(19) United States
(12) Patent Application Publication
(10) Pub. No.: US 2013/0247051 A1
(43) Pub. Date: Sep. 19, 2013

(54) IMPLEMENTATION OF A PROCESS BASED ON A USER-DEFINED SUB-TASK SEQUENCE

(71) Applicants: Fan Sun, Shanghai (CN); Mingjian Hu, Shanghai (CN); Wang Shiguo, Shanghai (CN); Ya Wang, Shanghai (CN); Haiyang Yu, Shanghai (CN)

(72) Inventors: Fan Sun, Shanghai (CN); Mingjian Hu, Shanghai (CN); Wang Shiguo, Shanghai (CN); Ya Wang, Shanghai (CN); Haiyang Yu, Shanghai (CN)

(21) Appl. No.: 13/001,431

(22) PCT Filed: Dec. 7, 2010
(86) PCT No.: PCT/CN10/79524

§ 371 Date: Dec. 27, 2010

(51) Int. Cl. G06F 9/48

(52) U.S. Cl. CPC G06F 9/48
USPC 718/102

(57) ABSTRACT

Various embodiments of systems and methods for implementation of a process based on a user-defined sub-task sequence are described herein. The process includes a set of sub-tasks. A plan owner defines the sequence in which the one or more sub-tasks are to be processed. In one embodiment, the plan owner defines the sequence by setting a fore-task for each sub-task in the sequence. The plan owner also defines a tester who would be processing each sub-task in the set of sub-tasks. A workflow template is triggered for implementing the process. The workflow template loops on the steps defined in the workflow template for processing each sub-task in the set of sub-tasks according to the sequence defined by the plan owner. Each tester after processing the sub-task assigned to them submits the processed sub-task. The process is implemented after all the sub-tasks in the set of sub-tasks have been processed.

### FIELD

Embodiments generally relate to computer software and systems, and more particularly to methods and systems for implementation of a process based on a user-defined sub-task sequence.

### BACKGROUND

A business process may include a plurality of sub-tasks that are to be processed for implementing the process. For example, SAP® software provides a set of workflow templates for implementing the business process. Each of these templates depicts a variant of how the business process is to be implemented.

At present, when a customer wants to implement the business process, he/she has to accept a pre-defined sequence for processing the plurality of sub-tasks. The pre-defined sequence can be “sequential”, i.e., when the sub-tasks are to be processed in a sequence one after the other. In another example, the predefined sequence can be “parallel”, i.e., when all the sub-tasks of the process are to be processed at the same time. For each of these sequences, a corresponding workflow template is created to implement the process.

There are limitations in both the “sequential” and the “parallel” sequences. In the “sequential” sequence each sub-task is to be processed one by one so it may waste a lot of time in case the process involves a large number of sub-tasks. On the other hand, the “parallel” sequence doesn't make sense when one sub-task's output is another sub-task's input.

Further, the present day systems do not allow the customer to configure the process at run-time, i.e., these systems do not allow the customer to assign the sub-task to different testers for processing at run time.

Therefore, a method that provides a flexible way to configure sub-tasks sequence for implementing the process is desired. Also, a method is desired that allows the process configuration at run time.

### SUMMARY

Various embodiments of systems and methods for implementation of a process based on a user-defined sub-task sequence are described herein. In one aspect, a fore-task associated with the set of sub-tasks is received, the fore-task including a sub-task from the set of sub-tasks whose processing is a prerequisite for processing a child sub-task from the set of sub-tasks. The fore-task defines a sequence of the set of sub-tasks for processing the set of sub-tasks. In another aspect, the workflow template is triggered for implementing the process. The triggering of the workflow template is triggered based on the sequence of the set of sub-tasks.

In a further aspect, the triggering of the workflow template includes forwarding the sub-task uploaded in the return sub-task list for processing. A child sub-task is retrieved from the sequence that has as its fore-task the sub-task forwarded for processing. The child sub-tasks is retrieved when the sub-task forwarded for processing has been processed. The workflow template is triggered for executing the retrieved child sub-task.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram illustrating a method for implementing a process, according to an embodiment.

FIG. 2 is a flow diagram illustrating a workflow template that is triggered to implement the process of FIG. 1, according to an embodiment.

FIG. 3 is a block diagram illustrating an exemplary system for implementing a process, according to an embodiment.

FIG. 4A is a block diagram illustrating an exemplary table received by a plan owner for setting a fore-task and a tester information for a set of sub-tasks of the process in FIG. 3, according to an embodiment.

FIG. 4B is a block diagram illustrating the table of FIG. 4A that has the fore-task and the tester information set by the plan owner, according to an embodiment.

FIG. 5 is a block diagram of a sequence of sub-tasks for processing the set of sub-tasks based on the fore-task set by the plan owner in FIG. 4B, according to an embodiment.

FIG. 6A-6B is a block diagram illustrating a table 600 received by the tester A for submitting the processed sub-task A, according to an embodiment.

FIG. 7 is a block diagram illustrating a computing environment in which the techniques described for implementation of a process based on a user defined sub-task sequence can be implemented, according to an embodiment.

### DETAILED DESCRIPTION

Embodiments of techniques for implementing a process including a set of sub-tasks are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

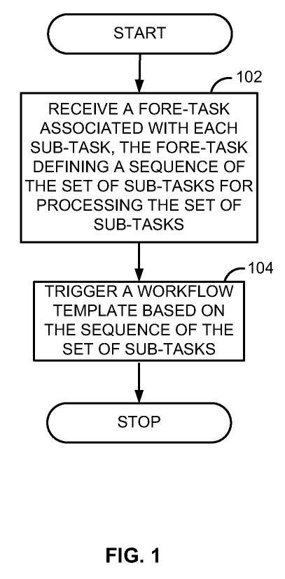

FIG. 1 is a flow diagram illustrating a method for implementing a process, according to an embodiment. The process may include a set of sub-tasks. In one embodiment, each sub-task in the set of sub-tasks is to be processed for implementing the process. In one embodiment, the process is a business process. In one embodiment, the process is a SAP® guidance, risk, and compliance solution (SAP® GRC solution). In one embodiment, the process is a manual testing.

Initially at block 102, a fore-task associated with each sub-task in the set of sub-tasks is received. In one embodiment, the fore-task includes a sub-task from the set of sub-tasks whose processing is a prerequisite for the processing of a child sub-task from the set of sub-tasks. In one embodiment the fore-task defines the sequence of the set of sub-tasks for processing the set of sub-tasks.

Consider an example of a process having two sub-tasks A and B (set of sub-tasks). The fore-task received for sub-task B is sub-task A. In this case, sub-task B is the child sub-task and can be processed only after sub-task A has been processed. As shown, the sequence of the set of sub-tasks for processing the set of sub-tasks (A and B) (i.e., sub-task A has to be processed before sub-task B) is defined based on the fore-task.

In one embodiment, the fore-task is received from a plan owner. In one embodiment, a request is sent to the plan owner for setting the fore-task for each sub-task in the set of sub-tasks. In one embodiment, the plan owner receives the request via an E-Mail. In one embodiment, the fore-task received from the plan owner is stored in a database. In one embodiment, the fore-task is set manually by the plan owner for each sub-task in the set of sub-tasks. In one embodiment, the plan owner sets the fore-task via the user interface.

In one embodiment, the fore-task is set as initial for a sub-task which is initial in the sequence of the set of sub-tasks. The fore-task for the sub-task is set as initial when the sub-task is not a child sub-task, i.e., when the processing of the sub-task is not dependent on the processing of another sub-task from the set of sub-tasks. In the example mentioned above, the fore-task for the sub-task A would be set as initial since the processing of sub-task A is not dependent on the processing of any other sub-task.

In one embodiment, tester information may be received. In one embodiment, the tester information is received from the plan owner. In one embodiment, the tester information includes information of a tester who will process the sub-task from the set of sub-tasks. In one embodiment, the tester information includes whether the sub-tasks are to be processed by one or more than one tester.

In one embodiment, the sub-task is forwarded to the tester for processing based on the tester information. In one embodiment, the sub-task is processed manually by the tester. In one embodiment, the processed sub-task is received from the tester. In one embodiment, the processed sub-task is stored in the database.

Next at block 104, a workflow template is triggered for implementing the process. In one embodiment, the workflow template is implemented based on the sequence of the set of sub-tasks defined by the fore-task in block 102. In one embodiment, the workflow template includes a set of steps. In one embodiment, triggering the workflow template includes performing the set of steps in the workflow template for processing each sub-task in the set of sub-tasks. In one embodiment, the set of steps in the workflow template are performed recursively for processing each sub-task in the set of sub-tasks based on the sequence of the set of sub-tasks received in block 102. In one embodiment, when the set of sub-tasks are completely processed the process is implemented.

In one embodiment, the workflow template is designed at design time. In one embodiment, the workflow template is a software code. In one embodiment, the fore-task associated with the set of sub-tasks and the tester information is received at run-time, i.e., after the workflow template has been designed and stored, and the set of sub-tasks have been received by the plan owner.

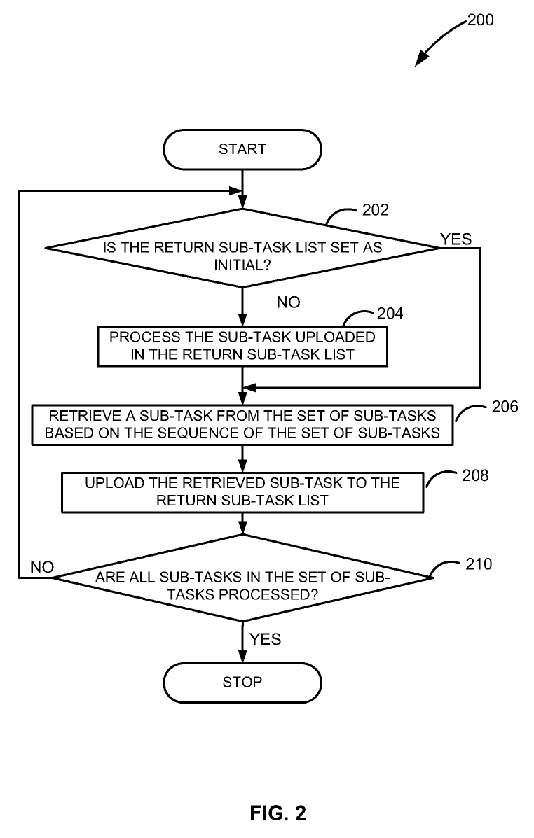

FIG. 2 is a flow diagram illustrating a set of steps performed when a workflow template 200 is triggered to implement the process of FIG. 1, according to an embodiment. In one embodiment, each sub-task in the set of sub-tasks is retrieved by the workflow template 200 for processing. In one embodiment, the sub-task provided to the workflow template 200 for processing is uploaded to a return sub-task list.

Initially when the workflow template 200 is triggered, a determination is made whether the return sub-task list is set as initial (block 202). In one embodiment, the return sub-task is set as initial when a return sub-task list is empty. In one embodiment, the return sub-task list includes the sub-task from the set of tub-tasks that is to be processed. In one embodiment, the return sub-task list is initially empty (i.e., does not include a sub-task) and is set as initial.

In one embodiment, when the workflow template 200 is triggered for the first time there would be no sub-task available for processing (i.e., the return sub-task list would be set as initial) and the condition in block 202 would be true. In this case, a sub-task that has the fore-task set as initial is retrieved from the set of sub-tasks (block 206, FIG. 2). In one embodiment, the retrieved sub-task that has the fore-task set as initial are uploaded to the return sub-task list (block 208, FIG. 2). In the example above, the sub-task A would be retrieved, as sub-task A is the initial sub-task in the set of sub-tasks.

In case, the return sub-task list is not set as initial (i.e., the return sub-task list has a sub-task) the condition in block 202 is false and the sub-task uploaded in the return sub-task list is processed (block 204).

In one embodiment, the sub-task is processed by forwarding the sub-task to the tester based on the tester information. In one embodiment, the tester receives the sub-task to be processed via an E-Mail. In one embodiment, the tester processes the sub-task manually. In one embodiment, the tester processes the sub-task and submits the processed sub-task.

After the sub-task is processed (block 204) the child sub-task of the sub-task processed in block 204 is retrieved (block 206). In the example discussed above, if the sub-task processed in block 204 is sub-task A then sub-task B (child sub-task) would be retrieved in block 206, as the fore-task of sub-task B is sub-task A that has been processed. In one embodiment, a check is performed whether the sub-task has been processed in block 204 before retrieving the child sub-task. In one embodiment, the sub-task retrieved is uploaded to the return sub-task list in block 206. In one embodiment, a flag is raised after the sub-task has been processed, the flag indicative that the child sub-task of the sub-task is to be retrieved.

Next, the child sub-task is uploaded to the return sub-task list, which includes the sub-task to be processed (block 208).

Next after the retrieved sub-task (child sub-task or the sub-task that has fore-task set as initial) is uploaded to the return sub-task list (block 208) a determination is made whether all the sub-tasks in the set of sub-tasks have been processed (block 210). In one embodiment, the determination is made by checking whether the return sub-task list includes a sub-task. In one embodiment, the return sub-task list would not include a sub-task after all the sub-tasks in the set of sub-tasks has been processed. In one embodiment, the process (that includes the set of sub-tasks) is implemented when all the sub-tasks in the set of sub-tasks has been processed. As shown, when all the sub-tasks in the set of sub-tasks have been processed the process ends. In the above example, after the sub-task B is processed (which is the last sub-task to be processed in the set of sub-tasks) no sub-task would be retrieved at block 206 (as there is no child sub-task of sub-task B). Therefore, the return sub-task list would not include a sub-task. In one embodiment, the process is implemented after the process ends as all the sub-tasks in the set of sub-tasks have been processed.

In case, all the sub-tasks in the set of sub-tasks have not been processed (i.e., the condition in block 210 is false) the workflow template 200 is triggered again. In one embodiment, the workflow template 200 is triggered again for the sub-task retrieved (at block 206) and uploaded to the return sub-task list (at block 208). In one embodiment, triggering the workflow template 200 again includes repeating the steps in blocks 202-210 for the sub-task (child sub-task or sub-task that has fore-task set as initial) retrieved at block 206 and uploaded to the return sub-task list at block 208. In the above example, the workflow template would be triggered for the first time for sub-task A that has the fore-task set as initial and for the second time for sub-task B that is a child sub-task dependent on the processing of sub-task A.

As shown, the workflow template 200 is triggered recursively for processing the set of sub-tasks in the process. In one embodiment, the process is implemented by traversing the workflow template 200 for each sub-task in the set of sub-tasks based on the sequence of the set of sub-tasks defined at block 102 of FIG. 1.

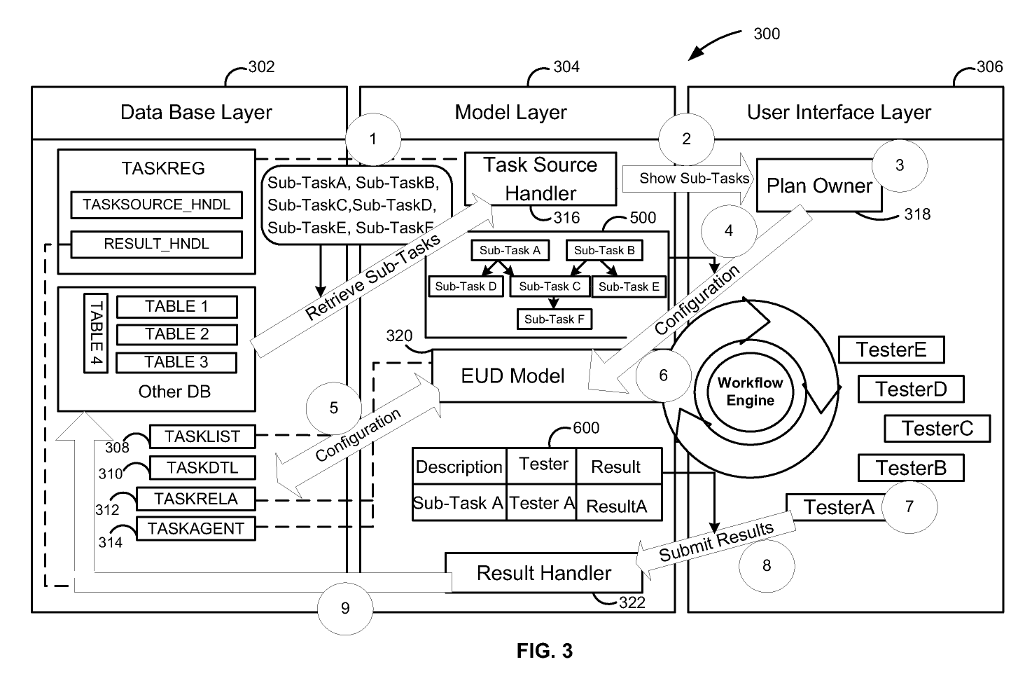

FIG. 3 illustrates an exemplary system 300 for implementing a process, according to an embodiment. As shown, the system 300 includes a database layer 302, which is used to store sub-task related information, a model layer 304, which is used to handle the processing of sub-tasks, and a user interface layer 306, which is provided to let users provide the sequence of the set of sub-tasks for processing the set of sub-tasks and process the sub-tasks. The process implemented by this exemplary system includes a set of five subtasks, subtask A-F.

The database layer 302 includes four tables that are provided to store data related to the set of sub-tasks (sub-task A-F). The four tables include a TASLIST table 308, TASKDTL table 310, TASKRELA table 312, and TASKAGENT table 314.

TASKLIST table 308 is used for the storage of the set of sub-tasks (sub-task A-F), the workflow template 200 (FIG. 2) would traverse the TASKLIST table 308 to retrieve each sub-task from the set of sub-tasks for processing.

TASKDTL table 310 is defined for the tester to update sub-task information (for example, the processed sub-task) and is used to store sub-task's detail information.

TASKRELA table 312 is defined for the plan owner to store the sequence of the set of sub-tasks for processing the set of sub-tasks by setting the sub-tasks' fore-tasks.

TASKAGENT table 314 is defined for the plan owner to maintain the tester information.

A series of steps 1-9 are performed by the system 300 for implementing the process. As shown initially at step 1, the set of sub-tasks A-F, of the process, stored in the TASKLIST table 308 is retrieved by a Task Source Handler 316. The set of sub-tasks retrieved by the Task Source Handler 316 is then presented to a plan owner 318 (step 2).

In one embodiment, the set of sub-tasks are presented to the plan owner 318 on a user interface. In one embodiment, the plan owner 318 receives the set of sub-tasks via an E-Mail. Next at step 3, the plan owner 318 configures a fore-task associated with the set of sub-tasks. In one embodiment, the fore-task defines the sequence of the set of sub-tasks for processing the set of sub-tasks. In one embodiment, the plan owner configures tester information. In one embodiment, the plan owner configures the fore-task and the tester information at run time, i.e., after the system 300 has provided the set of sub-tasks to the plan owner 318. In one embodiment, the plan owner 318 configures the fore-task and the tester information manually.

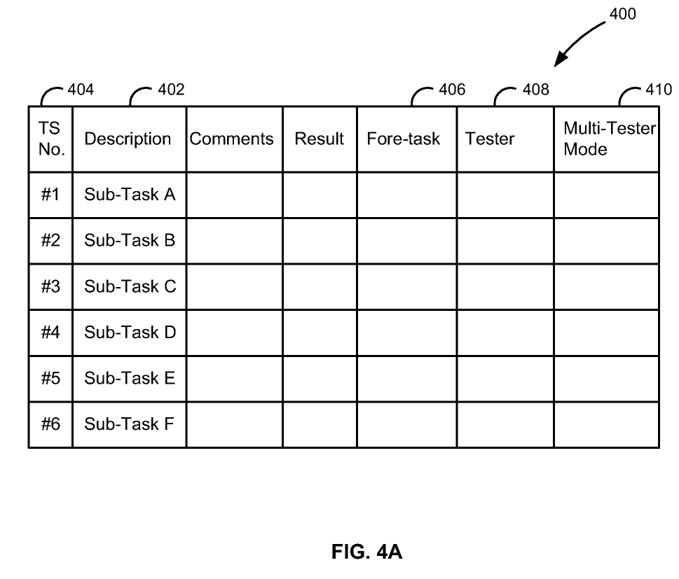

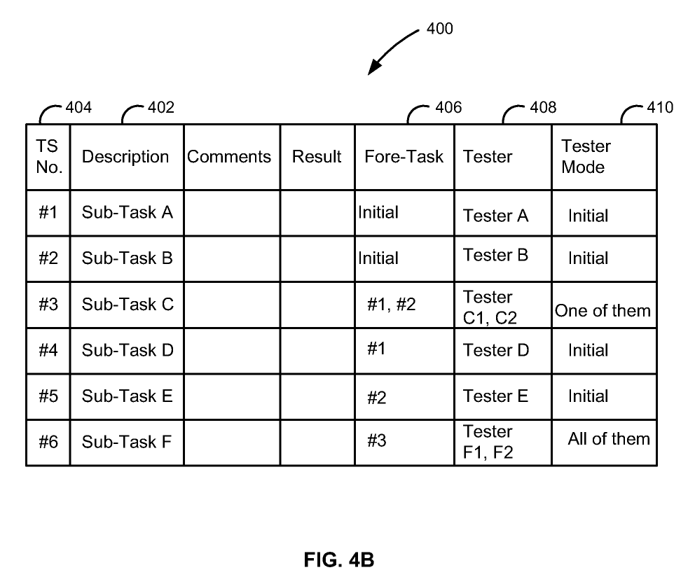

FIG. 4A illustrates an exemplary table 400 received by the plan owner 318 for setting the fore-task and the tester information for the set of sub-tasks A-F, according to an embodiment. As shown, the table 400 includes the set of sub-tasks A-F (description 402) and a task number (TS No.) 404 for each sub-task in the set of sub-tasks 402. In one embodiment, the plan owner 318 sets the fore-task 406 for each sub-task in the set of sub-tasks 402. In one embodiment, the plan owner 318 is required to provide the tester information (tester 408 and tester mode 410). In one embodiment, the tester 408 column defines the tester for processing each sub-task in the set of sub-tasks 402. In one embodiment, the tester mode 410 defines whether the sub-task is to be performed by one or more than one tester defined in the tester 408 column. In one embodiment, the tester mode 410 is set as “initial”, i.e., the sub-task is to be processed by the tester to whom the sub-task has been assigned. In one embodiment, the tester mode 410 is “one of them”, i.e., the sub-task is to be processed by one of the tester from the set of testers to whom the sub-task has been assigned. In one embodiment, the tester mode 410 is set as “all of them”, i.e., the sub-task is to be processed by all the testers to whom the sub-task has been assigned.

FIG. 4B illustrates the table 400 of FIG. 4A that has the fore-task 406 and the tester information (the tester 408 and the tester mode 410) set by the plan owner 318, according to an embodiment. As shown, the plan owner 318 sets the fore-task 406 for sub-tasks A and B as initial, i.e., these two sub-tasks would be processed initially in the sequence. The fore-task 406 for sub-task C is set as #1, #2 (TS No. 404), i.e., sub-task A, sub-task B. Therefore, the processing of sub-task A and sub-task B is a pre-requisite for the processing of sub-task C.

The fore-task 406 for sub-task D is set as #1, i.e., the processing of sub-task A is a prerequisite for processing of sub-task D. Next, the fore-task 406 for sub-task E is set as #2, i.e., the processing of the sub-task B is a pre-requisite for processing the sub-task E. The fore-task 406 for sub-task F is set as #3, i.e., the processing of sub-task C is a pre-requisite for processing the sub-task F.

The tester 408 is set for each sub-task from the set of sub-tasks A-F by the plan owner 318. Sub-Task A is assigned to Tester A, sub-task B is assigned to Tester B, sub-task C is assigned to Tester C1 and C2, sub-task D is assigned to Tester D, sub-task E is assigned to Tester E, and sub-task F is assigned to Tester F1 and Tester F2.

The tester mode 410 defines whether the sub-task would be performed by one or more testers. As shown, the tester mode for sub-task A, sub-task B, sub-task D, and sub-task E is set as initial as each sub-task is assigned to a single tester, Tester A, Tester B, Tester D, and Tester E, respectively for processing these sub-tasks. The tester mode for sub-task C is set as “one of them”, i.e., the sub-task C can be performed by either one of the testers C1 or C2. In one embodiment, the sub-task C is received by both tester C1 and C2. In one embodiment, the sub-task C is received by the tester C1 and C2 via E-Mail. In one embodiment, only one of the testers C1 and C2 who open the sub-task first is able to process the sub-task C. The tester mode for sub-task F is set as “all of them”, i.e., the sub-task F is to be processed by both the testers F1 and F2.

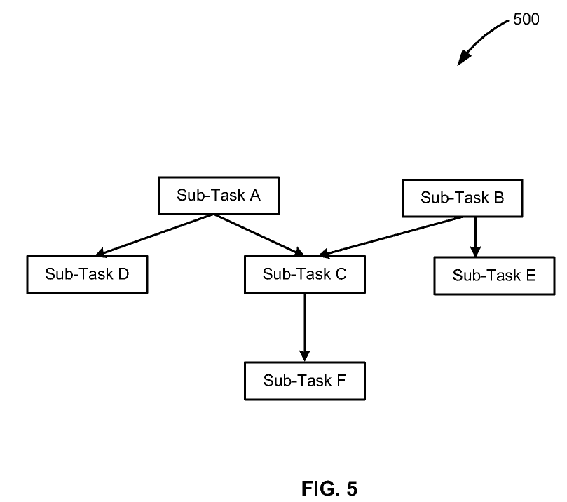

FIG. 5 is a block diagram of a sequence 500 of the set of sub-tasks for processing the set of sub-tasks A-F defined based on the fore-tasks 408 set by the plan owner 318 in FIG. 4B, according to an embodiment. As shown, the sub-task A and B are initial sub-tasks which are to be processed initially. Sub-Task C is a child sub-task whose processing is dependent on the processing of sub-task A and sub-task B. Similarly, sub-task D and sub-task E are child sub-tasks dependent on the processing of sub-task A and sub-task B. Sub-Task F is a child sub-task dependent on the processing of sub-task C, i.e., processing of sub-task F is dependent on the processing of sub-task C.

Next at step 4 and step 5 (FIG. 3) the fore-task 406 (FIG. 4B) and the tester information (tester 408, and tester mode 410 (FIG. 4B)) configured by the plan owner 318 in table 400 (FIG. 4B) is stored. In one embodiment, the fore-task 406 associated with the set of sub-tasks is stored in the TASKRELA table 312. In one embodiment, the tester information is stored in the TASKAGENT table 314.

In one embodiment, the system 300 includes an Extensible User Defined (EUD) model 320. In one embodiment, the workflow template 200 (FIG. 2) is stored in the EUD model 320. In one embodiment, the workflow template 200 is stored in the EUD model 320 at design time.

As shown in step 5 (FIG. 3), the EUD model 320 can retrieve the sub-tasks A-F from the TASKLIST register 308, the sequence of the set of sub-tasks for processing (i.e., the fore-task) the sub-tasks A-F from the TASKRELA register 312, and the tester information from the TASKAGENT register 314.

Next at step 6 (FIG. 3), the EUD model 320 which stores the workflow template 200 is triggered. Triggering the EUD model 320 triggers the workflow template 200 (FIG. 2). When the workflow template 200 is triggered for the first time there are no sub-tasks available for processing, i.e. the return sub-task is set as initial (block 202, FIG. 2). The EUD model 320 then retrieves the sub-tasks (sub-task A and sub-task B) whose fore-task are set as initial from the TASKLIST table 308 (block 206, FIG. 2). In one embodiment, the sub-tasks retrieved from the TASKLIST table 308 are uploaded in the return sub-task list (block 208, FIG. 2). In one embodiment, the sub-task to be processed is a dynamic data retrieved from the TASKLIST table 308 at run-time. In one embodiment, the return sub-task list is not stored in the database layer 302.

Next a check is performed whether all the sub-tasks in the set of sub-tasks have been processed (block 210, FIG. 2). In one embodiment, the check is performed by determining whether the return sub-task list includes a sub-task. The return sub-task list includes sub-task A and sub-task B, therefore the workflow template 200 is triggered again for the sub-tasks A and B retrieved from TASKLIST register 308 and uploaded in the return sub-task list.

When the workflow template 200 is triggered again, a check is performed whether the return sub-task list is set as initial (block 202, FIG. 2). In this case the return sub-task list includes sub-tasks A and B (i.e., the return sub-task list is not initial, block 202, FIG. 2). The sub-task A and B included in the return sub-task list are forwarded to tester A and tester B (based on tester information retrieved from the TASKAGENT table 314), respectively for processing (block 204, FIG. 2). In one embodiment, the testers A and B receive the sub-tasks A and B via an E-Mail. Next, the tester A and B process the received sub-task A and B, respectively (step 7). In one embodiment, the testers A and B manually processes the sub-tasks A and B, respectively.

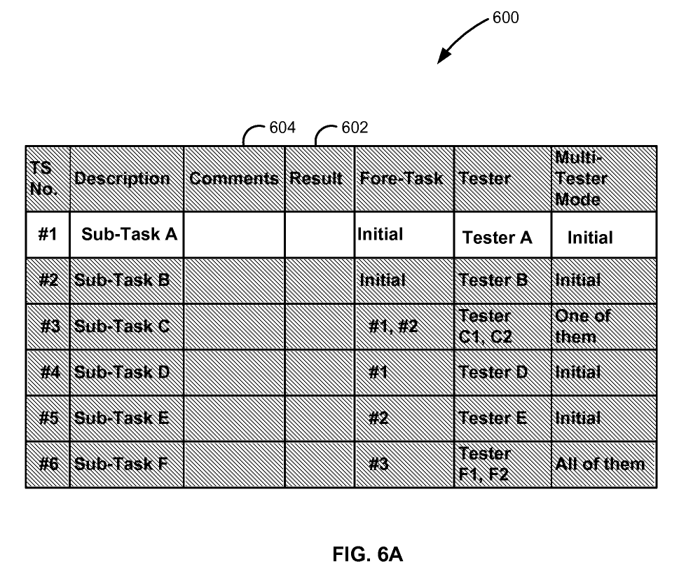

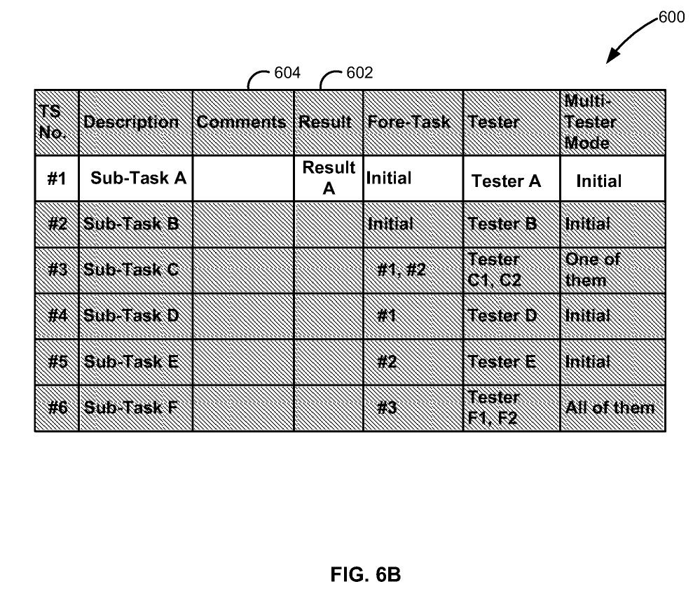

FIG. 6A-6B illustrates an exemplary table 600 received by the tester A for processing sub-task A, according to an embodiment. As shown, the table 600 has a result column 602 and a comment column 604. In one embodiment, after the tester processes the sub-task, the tester can manually update the result of the processing of sub-task in the result column 602 corresponding to the sub-task. In one embodiment, the tester can also provide comments 604 related to the processing of the sub-task. In one embodiment, the attribute of the table 600 received by a tester is such that the tester can only edit the result 602 and the comment 604 entries corresponding to the sub-task assigned to them, and the rest of the table is “read only” for the tester (i.e., cannot be changed by the tester). As shown, the tester A can only edit the result 602 and the comment 604 entries corresponding to sub-task A that is assigned to tester A and the rest of the table 600 is “read only” for tester A. Similarly, tester B would receive a table that allows the tester B to change the result 602 and comment 604 entries corresponding to sub-task B.

As shown in FIG. 6B, after the Tester A processes the sub-task A the tester A can update the result (processed sub-task A) in the result column 602. The other testers (B-F) can also update the result column 602 after processing the sub-task assigned to them.

Next after the tester has processed the sub-task (step 7) the tester submits the processed sub-task that is stored in the TASKDTL table 310 through a result handler 322 (step 8-9). The tester A and B after completing the processing of sub-task A and B, respectively submit the processed sub-task A and sub-task B, respectively (step 8). The processed sub-task A and the processed sub-task B are stored in the TASKDTL register 310 (step 9). As shown, the tester A submits the processed sub-task A (by updating the result column 602 in the table 600 with result A (processed sub-task A)) that is stored in the TASKDTL register 310.

In one embodiment, when the tester submits the processed sub-task (step 8) a flag is raised to informs the EUD model 320 that the sub-task has been processed. In one embodiment, the flag is indicative that the workflow template 200 is to be triggered again for the child sub-task whose processing depends on the processing of the processed sub-task. In one embodiment, a check is performed whether the sub-task has been processed before triggering the workflow template 200 again for the child sub-task.

Consider an example when tester A submits the result (processed sub-task A) before tester B submits the result (processed sub-task B). The child sub-tasks for sub-task A are sub-task C and sub-task D whose processing is dependent on the processing of sub-task A. However as shown in FIG. 5, the processing of sub-task C is dependent on the processing of sub-task B as well (which has not yet been processed). Therefore, the EUD model 320 only retrieves the sub-task D from the TASKLIST 308 (block 206, FIG. 2). In one embodiment, the retrieved sub-task D is uploaded to the return sub-task list (block 208, FIG. 2).

Next a check is performed whether all the sub-tasks in the set of sub-tasks have been processed (block 210, FIG. 2). In one embodiment, the check is performed by determining whether the return sub-task list includes a sub-task. In this case, the return sub-task list includes sub-task D therefore the workflow template 200 is triggered again for the sub-tasks D retrieved from TASKLIST register 308 and uploaded in the return sub-task list.

When the workflow template 200 is triggered again, a check is performed whether the return sub-task list is set as initial (block 202, FIG. 2). In this case the return sub-task list includes sub-task D for processing (i.e., the return sub-task list is not set as initial, block 202 FIG. 2). The sub-task D included in the return sub-task list is forwarded to tester D (block 204, FIG. 2). The tester D processes the sub-task D (step 7) and submits the processed sub-task D (step 8) that is stored in the TASKDTL register 310 (step 9).

Next after the tester B submits the processed sub-task B (block 204, FIG. 2) the sub-task C (whose fore-task is sub-task A and B) and sub-task E (whose fore-task is sub-task B) are retrieved from the TASKLIST 308 (block 206, FIG. 2). In one embodiment the sub-task C and sub-task E are uploaded in the return sub-task list (block 208, FIG. 2).

Next a check is performed whether all the sub-tasks in the set of sub-tasks have been processed (block 210, FIG. 2). In one embodiment, the check is performed by determining whether the return sub-task list includes a sub-task. In this case the return sub-task list includes sub-task C and sub-task E, therefore the workflow template 200 is triggered again for the sub-tasks C and E retrieved for TASKLIST register 308 and uploaded in the return sub-task list.

When the workflow template 200 is triggered again, a check is performed whether the return sub-task list is set as initial (block 202, FIG. 2). In this case the return sub-task list includes sub-task C and sub-task E (i.e., the return sub-task list is not initial, block 202 FIG. 2). The sub-task C included in the return sub-task list is forwarded to tester C1 and C2 for processing (block 204, FIG. 2). As discussed above, the tester mode for sub-task C is set as “one of them” (FIG. 4B). In one embodiment, both tester C1 and C2 receive the sub-task C as an E-Mail. Since the tester mode is set is “one of them” only one of the testers C1 and C2 who open the E-Mail, having the sub-task, first is able to process the sub-task C. In one embodiment, the tester (C1 or C2) processes the sub-task C (step 7). In one embodiment, the tester (C1 or C2) submit the processed sub-task C (step 8) which is stored in the TASKDTL list 310 (step 9).

The sub-task E is forwarded from the return sub-task list to the Tester E who processes the sub-task E (step 7). The tester E submits the processed sub-task E (step 8) which is stored in the TASKDTL register 310.

After the processed sub-task C is submitted the child sub-task F whose fore-task is sub-task C is retrieved from the TASKLIST 308 (block 206, FIG. 2). In one embodiment, the processed sub-task C is uploaded in the return sub-task list (block 208, FIG. 2).

Next a check is performed whether all the sub-tasks in the set of sub-tasks have been processed (block 210, FIG. 2). In one embodiment, the check is performed by determining whether the return sub-task list includes a sub-task. In this case the return sub-task list includes sub-task F, therefore the workflow template 200 is triggered again for the sub-task F retrieved from TASKLIST register 308 and uploaded in the return sub-task list.

When the workflow template 200 is triggered again, a check is performed whether the return sub-task list is set as initial (block 202, FIG. 2). In this case the return sub-task list includes sub-task F (i.e., the return sub-task list is not initial, block 202 FIG. 2). The sub-task F included in the return sub-task list is forwarded to testers F1 and F2 for processing. As discussed above, the tester mode for sub-task F is set as “all of them.” As the tester mode is set to “all of them” each of the testers F1 and F2 have to process the sub-task F. After the tester F1 and F2 process the sub-task F (step 7), the processed sub-task F is submitted (step 8) and stored in the TASKDTL register 310 (block 204, FIG. 2) (step 9).

Next a sub-task whose fore-task is same as the processed sub-task F is to be retrieved (block 206, FIG. 2). As sub-task F is the last sub-task (i.e., sub-task F does not have a child sub-task that depends on the processing of sub-task F) in the sequence of the set of sub-tasks there is no sub-task whose fore-task is same as the processed sub-task F. The return sub task-list would therefore not include a sub-task as all the sub-tasks in the TASKLIST table 308 have been processed.

Finally a check is performed whether all the sub-tasks in the set of sub-tasks have been processed (block 210, FIG. 2). In one embodiment, the check is performed by determining whether the return sub-task list includes a sub-task. As the return sub-task list does not include a sub-task the workflow template 200 (FIG. 2) is exited. As all the sub-tasks A-F included in the process have been processed, the process is implemented.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

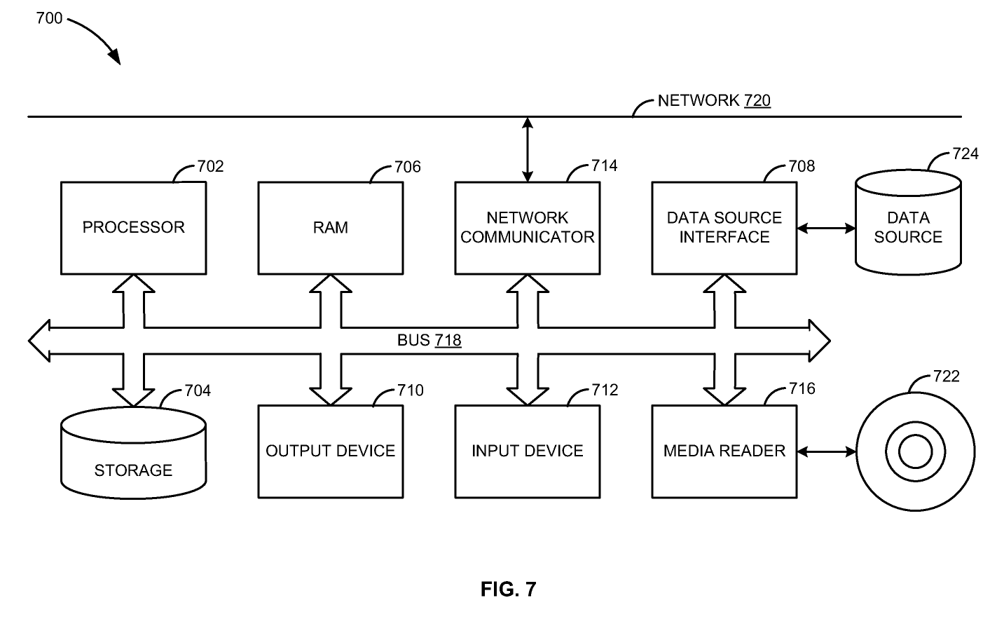

FIG. 7 is a block diagram of an exemplary computer system 700. The computer system 700 includes a processor 702 that executes software instructions or code stored on a computer readable storage medium 722 to perform the above-illustrated methods of the invention. The computer system 700 includes a media reader 716 to read the instructions from the computer readable storage medium 722 and store the instructions in storage 704 or in random access memory (RAM) 706. The storage 704 provides a large space for keeping static data where at least some instructions could be stored for later execution. The stored instructions may be further compiled to generate other representations of the instructions and dynamically stored in the RAM 706. The processor 702 reads instructions from the RAM 706 and performs actions as instructed. According to one embodiment of the invention, the computer system 700 further includes an output device 710 (e.g., a display) to provide at least some of the results of the execution as output including, but not limited to, visual information to users and an input device 712 to provide a user or another device with means for entering data and/or otherwise interact with the computer system 700. Each of these output devices 710 and input devices 712 could be joined by one or more additional peripherals to further expand the capabilities of the computer system 700. A network communicator 714 may be provided to connect the computer system 700 to a network 720 and in turn to other devices connected to the network 720 including other clients, servers, data stores, and interfaces, for instance. The modules of the computer system 700 are interconnected via a bus 718. Computer system 700 includes a data source interface 708 to access data source 724. The data source 724 can be accessed via one or more abstraction layers implemented in hardware or software. For example, the data source 724 may be accessed by network 720. In some embodiments the data source 724 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method for implementing a process including a set of sub-tasks, the method comprising:
receiving a fore-task associated with the set of sub-tasks, the fore-task comprising a sub-task from the set of sub-tasks whose processing is a prerequisite for processing a child sub-task from the set of sub-tasks, the fore-task defining a sequence of the set of sub-tasks for processing the set of sub-tasks; and
triggering a workflow template for implementing the process, the workflow template being triggered based on the sequence of the set of sub-tasks, wherein triggering the workflow template comprises:
forwarding the sub-task uploaded in a return sub-task list for processing;
retrieving the child sub-task that has as its fore-task the sub-task forwarded for processing, the child sub-task being retrieved when the sub-task forwarded for processing has been processed; and
triggering the workflow template for executing the retrieved child sub-task.

2. The method according to claim 1, wherein triggering the workflow template further comprises:
checking whether the set of sub-tasks have been processed, wherein the process is implemented when the set of sub-tasks have been processed.

3. The method according to claim 1, wherein the fore-task is set as initial when the sub-task is initial in the sequence of the set of sub-tasks.

4. The method according to claim 3, wherein the return sub-task list is initially empty, and wherein the sub-task that has the fore-task as initial is uploaded in the return sub-task list when the return sub-task list is empty.

5. The method according to claim 1, wherein triggering the workflow template further comprises:
checking whether the sub-task has been processed.

6. The method according to claim 1, further comprising:
receiving a tester information, the tester information including information of a tester for performing the set of sub-tasks;
forwarding the sub-task to the tester for processing, based on the tester information; and
receiving the processed sub-task processed by the tester.

7. The method according to claim 6, wherein the tester information includes a tester mode, the tester mode defining whether the sub-task is to be processed by one or more testers.

8. The method according to claim 1, wherein the child sub-task is uploaded to the return sub-task list.

9. An article of manufacture including a computer readable storage medium to tangibly store instructions, which when executed by a computer, cause the computer to:
receive a fore-task associated with the set of sub-tasks, the fore-task comprising a sub-task from the set of sub-tasks whose processing is a prerequisite for processing a child sub-task from the set of sub-tasks, the fore-task defining a sequence of the set of sub-tasks for processing the set of sub-tasks; and
trigger a workflow template for implementing a process, the workflow template being triggered based on the sequence of the set of sub-tasks, wherein triggering the workflow template comprises:
forward the sub-task uploaded in a return sub-task list for processing;
retrieve the child sub-task that has as its fore-task the sub-task forwarded for processing, the child sub-task being retrieved when the sub-task forwarded for processing has been processed; and
trigger the workflow template for executing the retrieved child sub-task.

10. The article of manufacture according to claim 9, further comprising instructions which when executed by the computer further causes the computer to:
check whether the set of sub-tasks have been processed, wherein the process is implemented when the set of sub-tasks have been processed.

11. The article of manufacture according to claim 9, wherein the fore-task is set as initial when the sub-task is initial in the sequence of the set of sub-tasks.

12. The article of manufacture according to claim 11, wherein the return sub-task list is initially empty, and wherein the sub-task that has the fore-task as initial is uploaded in the return sub-task list when the return sub-task list is empty.

13. The article of manufacture according to claim 9, further comprising instructions which when executed by the computer further causes the computer to:
check whether the sub-task has been processed.

14. The article of manufacture according to claim 9, further comprising instructions which when executed by the computer further causes the computer to:
receive a tester information, the tester information including information of a tester to perform the set of sub-tasks;
forward the sub-task to the tester for processing based on the tester information; and
receive the processed sub-task processed by the tester.

15. The article of manufacture according to claim 14, wherein the tester information includes a tester mode, the tester mode defines whether the sub-task is to be processed by one or more testers.

16. The article of manufacture according to claim 9, wherein the child sub-task is uploaded to the return sub-task list.

17. A computer system for implementing a process including a set of sub-tasks, the computer system comprising:
a memory to store a program code; and
a processor communicatively coupled to the memory, the processor configured to execute the program code to:
receive a fore-task associated with the set of sub-tasks, the fore-task comprising a sub-task from the set of sub-tasks whose processing is a prerequisite for processing a child sub-task from the set of sub-tasks, the fore-task defining a sequence of the set of sub-tasks for processing the set of sub-tasks; and
trigger a workflow template for implementing the process, the workflow template being triggered based on the sequence of the set of sub-tasks, wherein triggering the workflow template comprises:
forward the sub-task uploaded in a return sub-task list for processing;
retrieve the child sub-task that has as its fore-task the sub-task forwarded for processing, the child sub-task being retrieved when the sub-task forwarded for processing has been processed; and
trigger the workflow template for executing the retrieved child sub-task.

18. The computer system according to claim 17, wherein the processor further executes the program code to:
check whether the set of sub-tasks have been processed, wherein the process is implemented when the set of sub-tasks have been processed.

19. The computer system according to claim 17, wherein the fore-task is set as initial when the sub-task is initial in the sequence of the set of sub-tasks.

20. The computer system according to claim 19, wherein the return sub-task is initially empty, and wherein the sub-task that has the fore-task as initial is uploaded in the return sub-task list when the return sub-task list is empty.

21. The computer system according to claim 17, wherein the processor further executes the program code to:
check whether the sub-task has been processed.

22. The computer system according to claim 17, wherein the processor further executes the program code to:
receive a tester information, the tester information including information of a tester for performing the set of sub-tasks;
forward the sub-task to the tester for processing based on the tester information; and
receive the processed sub-task processed by the tester.

23. The computer system according to claim 22, wherein the tester information includes a tester mode, the tester mode defining whether the sub-task is to be processed by one or more than one testers.

24. The computer system according to claim 17, wherein the child sub-task is uploaded to the return sub-task.
